(19) United States
(12) Patent Application Publication
(10) Pub. No.: US 2003/0024554 A1
(43) Pub. Date: Feb. 6, 2003

(54) Object washing apparatus

(76) Inventors: Robert H. Schultz, Golden, CO (US); Jack Kowal, Arvada, CO (US)

Correspondence Address: Michael A. Goodwin, Esq., Klaas, Law, O'Meara & Malkin, P.C., 1999 Broadway, Suite 2225, Denver, CO, 80202, US

(21) Appl. No.: 09/921,457

(22) Filed: Aug. 3, 2001

(51) Int. Cl. B08B 3/02

(52) U.S. Cl. 134/33; 134/80; 134/152; 134/153

(57) ABSTRACT

A high-speed object washer may be provided for receiving a plurality of objects at an entrance portion, engaging a retention turntable and progressing into a cover. While traveling in the cover in a rotary direction, various cleaning operations may be performed to the object in order to remove various contaminates. After traveling in the rotary direction under the cover, the object may egress from the object washer at an exit portion. The object egresses from the exit portion clean and contaminate-free.

### FIELD OF THE INVENTION

The present apparatus relates to the washing of objects in a production environment as part of the manufacturing process.

### BACKGROUND OF THE INVENTION

It is often necessary to wash manufactured objects to remove contaminants, such as lubricants, that may be introduced during the manufacturing process. One type of manufactured object that commonly requires washing is a container. A particular type of container, commonly referred to as a “can”, is typically constructed from a metallic material, such as steel or aluminum.

Cans have long been used as containers for storing and dispensing beverages. The type of beverage can most commonly used today is known in the can-making industry as a “two-piece” can. Aptly enough, this type of can is constructed of two pieces—a body portion and a closure member.

A typical two-piece beverage can includes a body portion and an end member attached to the body portion. The can body portion comprises a generally cylindrical portion which has an open end and a closed end. The open end is generally provided with a necked-in portion, commonly referred to in the industry as a “neck”. The can neck typically terminates in a flanged end, which is commonly referred to in the industry as a “flange”. The flange facilitates attachment of the can end to the can body. The neck allows an end to be used which is smaller in diameter than the cylindrical portion of the can body.

The closed end of the can body portion generally includes an annular rim and an inwardly domed portion. The domed portion is configured to resist the pressure generated by a beverage contained within the can, particularly a carbonated beverage. In this manner, the can may be placed and/or conveyed on a flat surface in a stable fashion resting on the rim.

The can body portion is most commonly constructed of steel or aluminum and is formed by a drawing and ironing process in which a can preform or “cup” is forced through a series of dies by a punch. In a typical drawing and ironing process, the cup first moves through a redraw die which causes the cup to conform to the shape of the punch. The punch then forces the redrawn cup through a series of ironing dies which stretch and thin the metal into an elongated cylindrical configuration. The sidewalls of drawn and ironed cans may, for example, only be about 0.004 inches thick at the thinnest part of the can sidewall. After clearing the ironing dies, the punch causes the closed end of the can to impact a doming die which creates the rim and domed profile described above.

The process outlined above may be carried out in a machine of the type commonly referred to in the industry as a “bodymaker” or a “wall ironer”. Examples of a bodymaker machine are disclosed in U.S. Pat. Nos. 3,696,657 to Maytag and 5,357,779 to Hahn et al., which are hereby specifically incorporated by reference for all that is disclosed therein.

After being drawn and ironed into a cylindrical configuration, the can body is trimmed to a desired height in a can trimming machine. Examples of such a can trimming machine are disclosed in U.S. Pat. Nos. 5,404,776 and 5,054,341 to Johansson et al. which are hereby specifically incorporated by reference for all that is disclosed therein.

After trimming, the can body is generally provided with an exterior decoration and an internal coating to prevent contact between the can contents and the metal forming the can. After decorating and coating, the can is then transferred to a machine or machines which form the neck and the flange as previously described. An example of a machine which necks and flanges cans is disclosed in U.S. Pat. No. 3,687,098 to Maytag which is hereby specifically incorporated by reference for all that is disclosed therein.

At this point, the can body is completely formed and is ready to be filled with a beverage and sealed with an end. An example of a can end is disclosed in U.S. Pat. No. 4,901,880 to Tatham et al. which is hereby specifically incorporated by reference for all that is disclosed therein.

During the can manufacturing process, as outlined above, the can body may be exposed to various lubricants and coolants. In the bodymaker machine, for example, a coolant may be used in order to cool the can and the dies as the can body is formed. This coolant may also include one or more lubricants in order to reduce the friction between the can body and the dies as the can is formed. Accordingly, at the time that a can exits the trimming machine, it will generally be coated with bodymaker coolant. In addition, lubricant previously applied to the cup or preform may still be present on the formed can at this point. Since the existence of such lubricants and coolants interferes with the ability to effectively decorate and internally coat the can body, as described above, it is conventional to pass formed can bodies through a can washer after they are trimmed and before they enter the can decorator.

Conventional can washers are long conveyer-belt lines. A bottom conveyer belt supports the cans as they enter, travel through, and egress from the conventional can washer. A top conveyer belt traps the cans during spraying operations as described herein. The conventional can washer receives a plurality of cans at an upstream end. The cans are received by the conventional can washer in a random pattern whereby the cans are grouped together. Since the cans are grouped together, they touch each other resulting in long small ‘tubes’ of space between each can. The cans travel down the length of the conventional can washer going through a variety of cleaning operations. A prewashing station is provided for spraying a solution of prewash solution. As the cans travel through the prewashing station, the top belt traps the cans in order to overcome the force of the prewashing solution. The prewashing solution is sprayed through the top and bottom conveyor belts onto the cans. A significant amount of the prewashing solution is deflected by the top and bottom conveyer belts as a result of their required surface area to support the cans.

At a downstream position from the prewashing station, a washing station is provided for spraying a solution of conventional wash solution. As the cans travel through the washing station, the top belt traps the cans in order to overcome the force of the washing solution. The washing solution is sprayed through the top and bottom conveyor belts. As previously mention, a significant amount of the washing solution is deflected by the top and bottom conveyer belts as a result of their required surface area to support the cans.

A rinse station is located downstream from the washing station. The rinse station sprays a solution of potable water onto the cans in order to remove the washing solution.

A final rinse station is located downstream from the washing station. The final rinse station sprays a solution of deionized water onto the cans in order to ensure that contaminate-free cans egress from the conventional can washer.

In-between the individual washing and rinsing stations are baffles for blowing off any remaining solutions. The baffles are air screens produced by blowing high-pressure air through nozzles. The baffles blow any remaining solution off of the cans in order to minimize cross-contamination of the various solutions. Such air baffles are substantially disclosed in U.S. Pat. No. 4,183,115 to Zakarian hereby specifically incorporated by reference for all that is disclosed therein.

A conventional can washer is capable of washing about 3000 cans per minute. At this rate, there are a large number of cans traveling on the bottom conveyer belt through the conventional can washer. Due to the large number of cans, the conventional can washer is a large system. The conventional can washer accepts cans from a plurality of bodymaker machines. After washing the cans, the cans are etched (a process for activating a metal surface to accept printing) and then delivered to a can decoration machine as described above.

The individual components of the can manufacturing process are susceptible to malfunctioning. In the event that a malfunction occurs, the entire can line often must be shut down. Due to the number of cans in the flow process, if a malfunction occurs at any location in the production line, the conventional can washer is slowed down. The slowing down of the conventional can washer may result in over-treatment of the cans. Over-treatment of the cans results in defective cans that need to be removed and discarded. Defects caused by over-treating may include color variations, problems in the necking region and friction in conveyor systems. Removing and discarding cans represents an economic loss, requiring extra time and manual labor.

An additional consideration associated with conventional can washers is the size of the can washer. Because all of the cans are received from a plurality of bodymaker machines, the actual size of the conventional can washer is rather large. The individual tanks holding the various cleaning solutions are proportionally large. In the event that a solution becomes contaminated, off-ratio, or otherwise unacceptable, changing or rejuvenating the solution becomes expensive and difficult due to the size of the tanks.

In addition to being used as containers for beverages, as generally discussed above, cans also find use as containers for storing other products, such as foods. Although two-piece cans are sometimes used for food products, a type of can commonly referred to as a “three-piece can” is more commonly used for this purpose.

During the manufacture of a typical three-piece can, a body portion is formed from a flat, typically rectangular, portion of steel. The portion is rolled into a cylindrical shape and then welded to form an annular can body that is open at both ends. The rectangular portion may be decorated prior to the rolling and welding operations or a label may be applied after the can is filled. After rolling and welding, an end is then seamed to one end of the can body. Thereafter, the interior of the can may be supplied with an internal coating, similar to the internal coating applied to a two-piece can as discussed above.

Prior to applying the internal coating, as described above, three-piece cans may be washed, in a manner similar to that described above, in order to remove lubricants or other contaminants that may have been introduced during the can manufacturing process. Accordingly, the problems discussed above, with respect to two-piece can washing are also applicable to a three-piece can manufacturing process.

### SUMMARY OF INVENTION

In one embodiment a washer for washing objects may have a housing and a rotatable member rotatably mounted to the housing at a rotation axis. The rotatable member may have an outer peripheral surface extending in a direction parallel to the rotation axis. The washer may have at least one stationary member stationarily mounted to the housing. Furthermore, at least one of the objects may be in contact with both the rotatable member outer peripheral surface and the stationary member.

In another embodiment a method of washing an object may include providing a housing, providing at least one nozzle within the housing and providing a rotatable member rotatably mounted to the housing at a rotation axis. The rotatable member may have an outer peripheral surface extending in a direction parallel to the rotation axis. The method may further include providing at least one stationary member stationarily mounted to the housing, rotating the rotatable member and causing the object to move relative to the housing by contacting the object with the rotatable member outer peripheral surface. The method may further include guiding the object within the housing by contacting the object with the at least one stationary member and spraying fluid from the at least one nozzle onto the object while the rotating and the guiding are occurring.

In another embodiment a washer for washing objects may have a housing, a rotatable member rotatably mounted to the housing at a rotation and at least one stationary member stationarily mounted to the housing. At least one of the objects may be located between the rotatable member and the at least one stationary member. At least one of the objects may be in contact with both the rotatable member and the stationary member.

### BRIEF DESCRIPTION OF THE DRAWINGS

FIG. 1 shows a top perspective of a can washer with a cover attached thereto.

FIG. 2 shows a top perspective of the can washer of FIG. 1 with the cover removed, thereby showing internal components.

FIG. 3 shows a side perspective of a spray manifold that may be one of the internal components shown in FIG. 2.

FIG. 4 shows a side perspective of a top air manifold that may be one of the internal components shown in FIG. 2.

FIG. 5 shows a side perspective of a circular air manifold that may be one of the internal components shown in FIG. 2.

FIG. 6 shows a top perspective of a retention turntable that may be one of the internal components shown in FIG. 2.

FIG. 7 shows a cut-away side view of the retention turntable of FIG. 6 and a can, the cut-away portion is shown in FIG. 2 as line 7-7.

FIG. 8 shows a cut-away side view of the can washer, the cut-away portion is shown in FIG. 2 as line 8-8.

### DETAILED DESCRIPTION OF THE INVENTION

Prior to providing detailed descriptions of the individual components of a high-speed can washer 100, a preliminary overview will be provided.

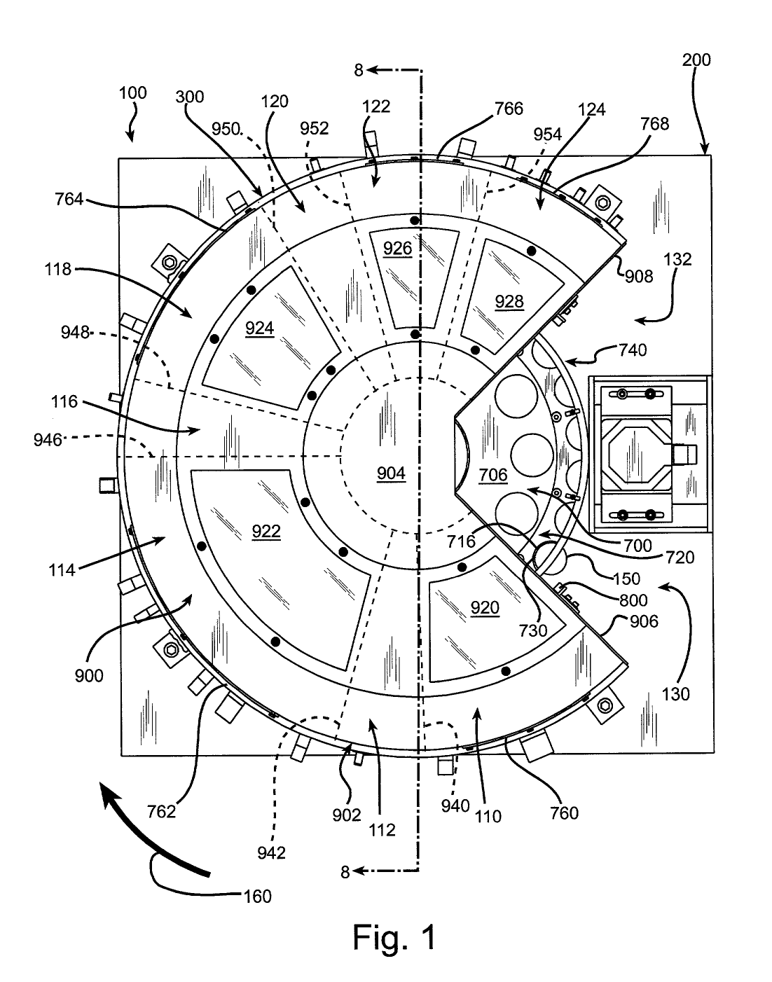

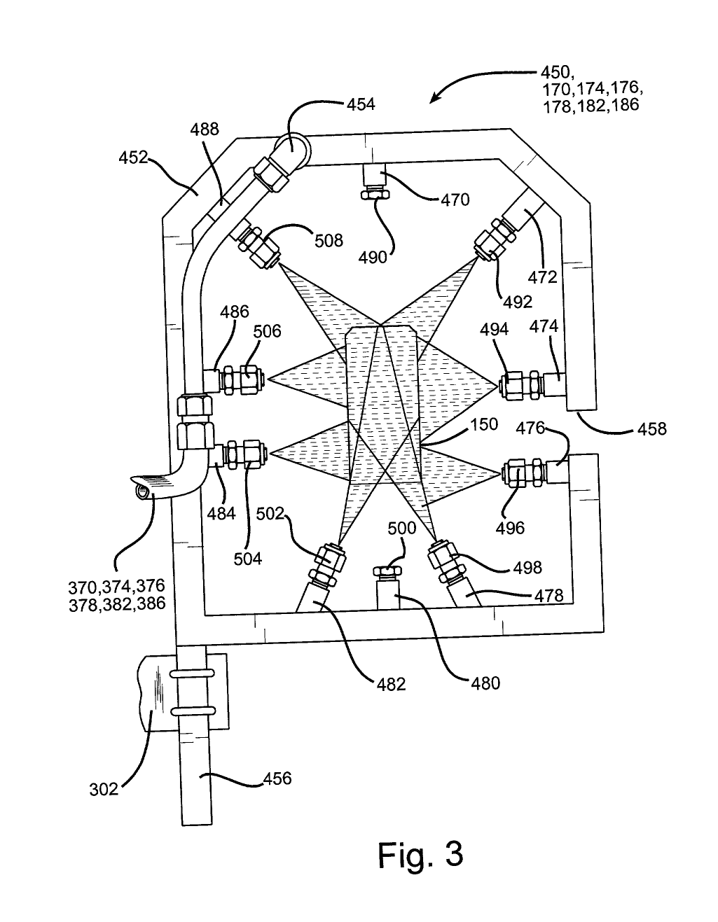

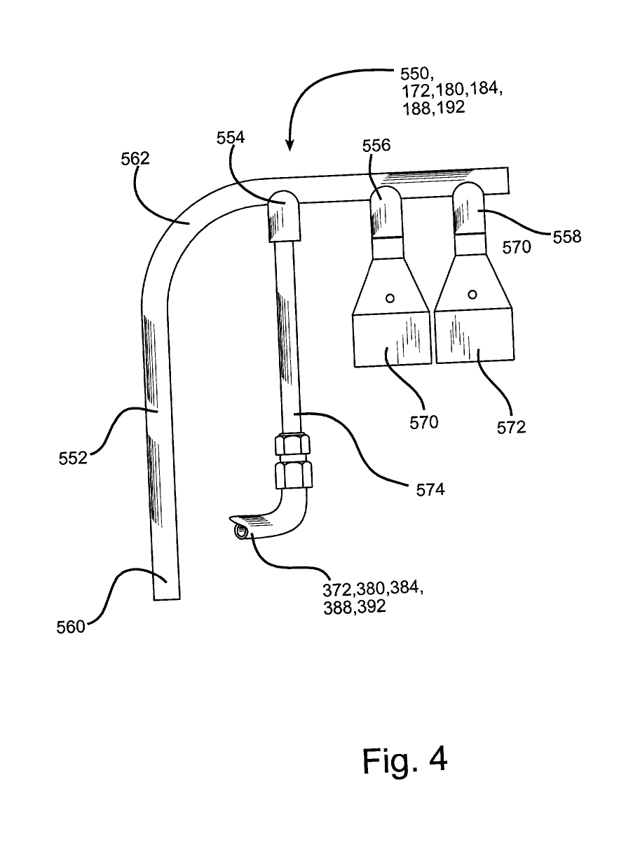

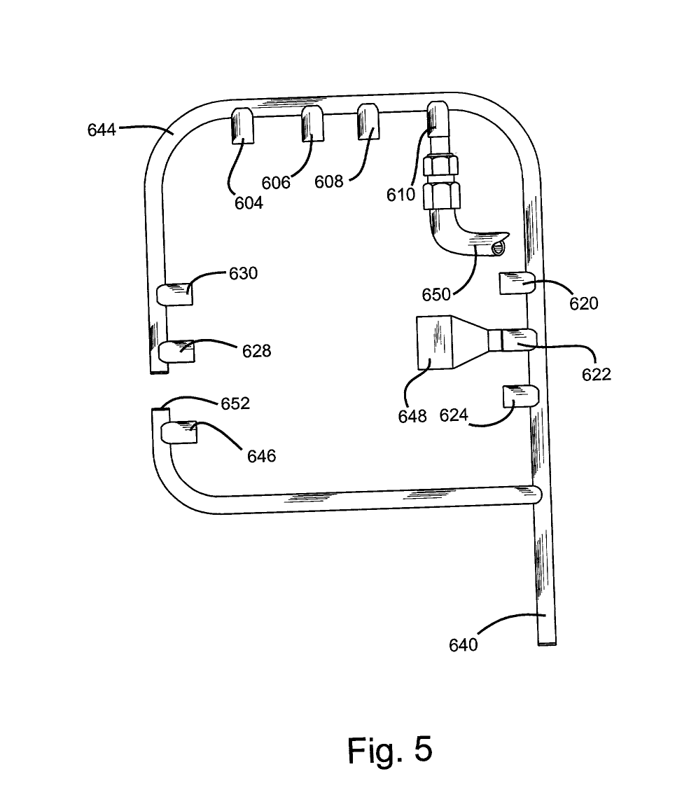

Referring to FIG. 1, the high-speed can washer 100 may be provided with a machine base 200, a tank assembly 300, a plurality of wash manifolds such as wash manifold 450 (FIG. 3), a plurality of top air manifolds such as top air manifold 550 (FIG. 4), a plurality of circular air manifolds such as circular air manifold 600 (FIG. 5), a retention turntable 700, a cover 900, an entrance portion 130 and an exit portion 132.

The can washer 100 may be provided for receiving a plurality of cans such as can 150 at the entrance portion 130, engaging the retention turntable 700 and progressing into the cover 900. While traveling in the cover 900 in a rotary direction 160, various cleaning operations may be performed to the can 150 at a plurality of stations in order to remove various contaminates. After traveling in the rotary direction 160 under the cover 900, the can 150 may egress from the can washer 100 at the exit portion 132. The can 150 that egresses from the exit portion 132 being clean and substantially contaminate-free.

Having provided a brief introduction to an exemplary embodiment of the present high-speed can washer, a detailed description of the subsystems and components thereof will now be provided.

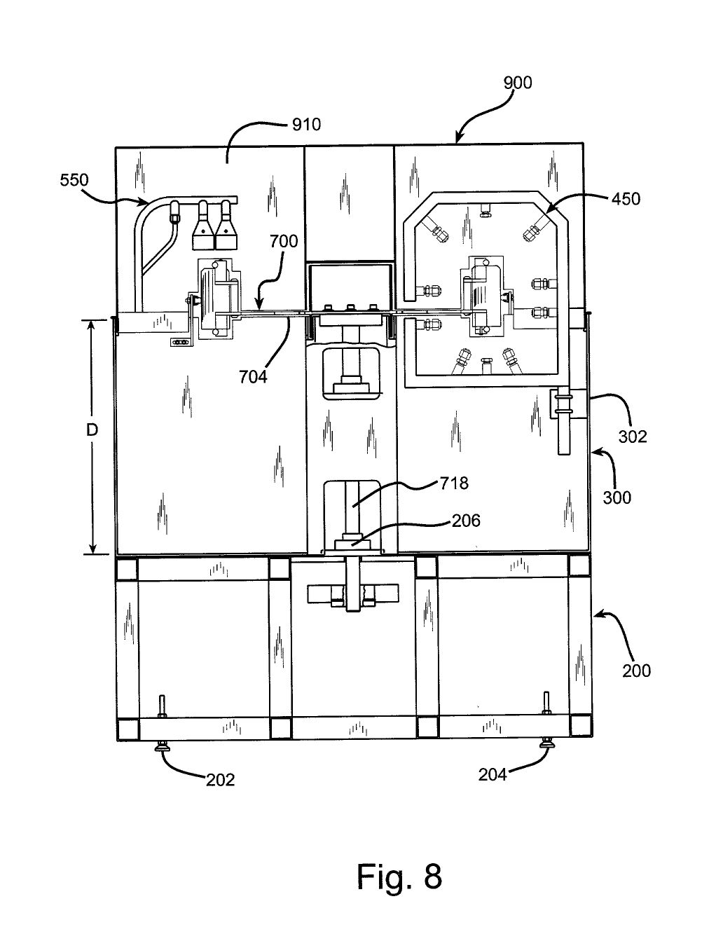

With reference to FIG. 8, the can washer 100 may be provided with a machine frame 200 with various components attached thereto. The machine frame 200 may be manufactured in the exemplary embodiment of welded structural tubing to provide a substantially rigid structure. The machine frame 200 may be provided with leveling pads, such as a first leveling pad 202 and a second leveling pad 204 for leveling the can washer 100. The machine frame 200 may be further provided with a plurality of bearings such as bearing 206. The machine frame 200 may be further provided with a motor mount (not shown) for receiving a motor (not shown).

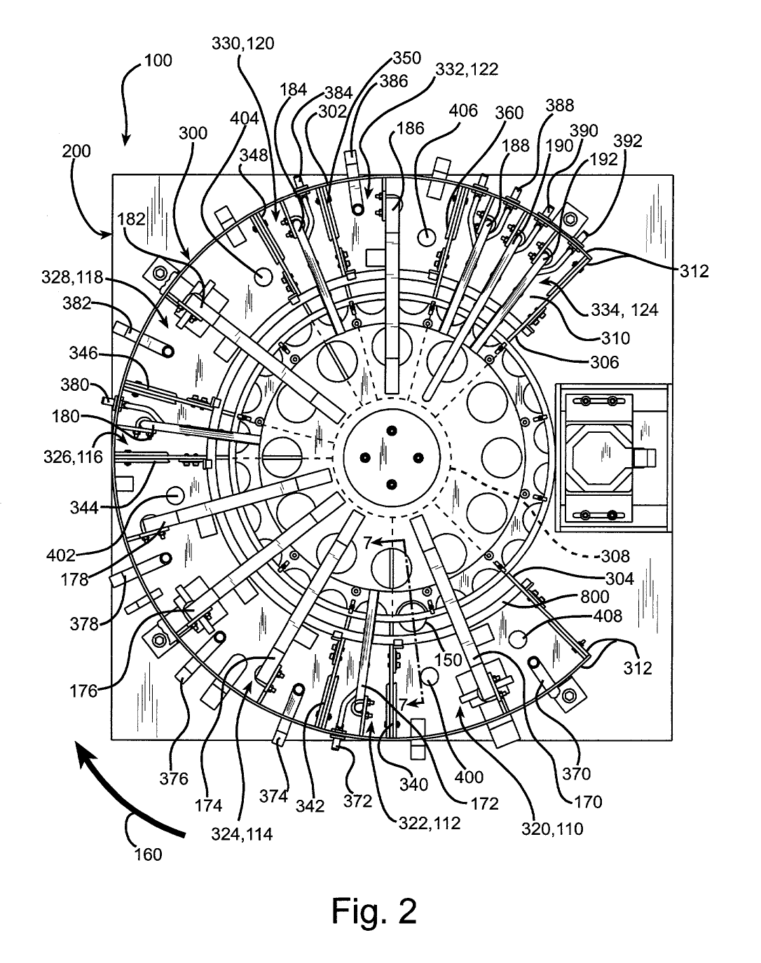

Referring to FIG. 2, a tank assembly 300 may be provided as a component of the can washer 100. In an exemplary embodiment, the tank assembly 300 is configured in a substantially circular geometry having a circumferential wall portion 302. The tank assembly 300 may be further provided with a tank entrance wall portion 304, a tank exit wall portion 306 and a center wall portion 308. The individual wall portions 302, 304, 306 and 308 are configured perpendicular to a bottom portion 310. The wall portions 302, 304, 306 and 308 and the bottom portion 310 may be assembled to define an outside tank perimeter 312 of the tank assembly 300. In the exemplary embodiment the tank assembly 300 may be welded steel constructed with water impermeable joints.

The outside tank perimeter 312 may be provided with internal partitions to create a plurality of individual tanks for receiving various solutions. The plurality of internal partitions may include partitions such as a prewash partition 340, a prewash dryer partition 342, a wash partition 344, a wash dryer partition 346, a rinse partition 348, a rinse dryer partition 350 and a final rinse partition 360. The plurality of individual tanks may include tanks such as a prewash tank 320, a prewash dryer recovery tank 322, a wash tank 324, a wash dryer recovery tank 326, a rinse tank 328, a rinse dryer recovery tank 330, a final rinse tank 332 and a final dryer tank 334.

The prewash tank 320 is separated from the prewash dryer recovery tank 322 by the prewash partition 340. The prewash tank 320 is therefore defined by the tank bottom portion 310, the tank entrance wall portion 304, the tank circumferential wall portion 302, the prewash partition 340 and the center wall portion 308. The prewash dryer recovery tank 322 is separated from the wash tank 324 by the prewash dryer partition 342. The prewash dryer recovery tank 322 is therefore defined by the tank bottom portion 310, the prewash partition 340, the circumferential wall portion 302, the prewash dryer partition 342 and the center wall portion 308. The wash tank 324 is separated from the wash dryer recovery tank 326 by the wash partition 344. The wash tank 324 is therefore defined by the prewash dryer partition 342, the circumferential wall portion 302, the wash partition 344 and the center wall partition 308. The wash dryer recovery tank 326 is separated from the rinse tank 328 by the wash dryer partition 346. Therefore, the wash dryer recovery tank 326 is defined by the tank bottom portion 310, the wash partition 344, the circumferential wall portion 302, the wash dryer partition 346 and the center wall portion 308. The rinse tank 328 is separated from the rinse dryer recovery tank 330 by the rinse partition 348. Therefore, the rinse tank 328 is defined by the tank bottom portion 310, the wash dryer partition 346, the circumferential wall portion 302, the rinse partition 348 and the center wall portion 308. The rinse dryer recovery tank 330 is separated from the final rinse tank 332 by the rinse dryer partition 350. Therefore, the rinse dryer recovery tank 330 may be defined by the tank bottom portion 310, the rinse partition 348, the circumferential wall portion 302, the rinse dryer partition 350 and the center wall partition 308. The final rinse tank 332 is separated from the final dryer tank 334 by the final rinse partition 360. Therefore the final rinse tank 332 is defined by the tank bottom portion 310, the rinse dryer partition 350, the circumferential wall portion 302, the final rinse partition 360 and the center wall portion 308. The final dryer tank 334 is defined by the tank bottom portion 310, the final rinse partition 360, the circumferential wall portion 302, the tank exit wall portion 306 and the center wall portion 308.

Referring still to FIG. 2, the individual tanks 320, 322, 324, 326, 328, 330, 332 and 334 may be provided with various inlets and outlets. The inlets are provided for introducing solutions or compressed air into the tank area 300. The outlets may be provided for removing solutions from the tank area 300. Examples of inlets may include inlets 370, 372, 374, 376, 378, 380, 382, 384, 386, 388 and 390. Examples of outlets may include outlets 400, 402, 404 and 406. Since the functions of the inlets and the outlets are substantially similar for the individual tanks, only one inlet and outlet will be described in detail.

In the exemplary embodiment, the wash tank 324 may be supplied wash solution by three individual inlets 374, 376 and 378. The solution is pumped from the wash tank 324 from the outlet 402 by a pump (not shown). The pump pressurizes the solution and delivers the solution to the three inlets 374, 376 and 378 by conventional tubing. In the exemplary embodiment, the pump may be of the type manufactured by Kerr Machine Company of P.O. Box 91, Ada, Okla. under the model name KZ-1000. As previously mentioned, this set of inlets and outlet 374, 376, 378 and 402 are substantially similar to other sets of fittings of the can washer 100. Additionally, the wash tank 320 may be provided with an overflow outlet 408. The overflow outlet 408 extends from the bottom portion 310 to a top surface (not shown) of the prewash solution. Removal of excess prewash solution may occur through the overflow outlet 408 if the too much prewash solution is located in the prewash tank 320.

In one embodiment of the present apparatus, the height of the internal tanks such as tanks 320, 324 and 328 (FIG. 2) may have varying depths denoted by “D” in FIG. 8. The varying depths may be provided to make it possible to constantly rejuvenate the various solutions. A predetermined flow rate, i.e. 2-3 gallons per minute, of clean potable water may be introduced to the rinse tank 328. The rinse tank 328 may be deeper than the wash tank 324 (for example, “D” for the rinse tank 328 may be 2 inches greater than “D” for the wash tank 324); therefore, rinse solution flows from the rinse tank 328 into the wash tank 324 at the same rate at which the potable water is introduced to the rinse tank 328. The rinse solution that flows from the rinse tank 328 into the wash tank 324 is drawn from the top surface of the rinse solution. Most of the contaminants in the rinse solution are lighter than the rinse solution; therefore, the rinse solution that flows into the wash tank 324 moves contaminates from the rinse tank 328 to the wash tank 324. The wash tank 324 may be deeper than the prewash tank 320 (for example, “D” for the wash tank 324 may be 2 inches greater than “D” for the prewash tank 320); therefore, wash solution flows from the wash tank 324 into the prewash tank 320 at the same rate at which the potable water is introduced to the rinse tank 328. The wash solution that flows from the wash tank 324 into the prewash tank 320 is drawn from the top surface of the wash solution. Most of the contaminants in the wash solution are lighter than the wash solution; therefore, the wash solution that flows into the prewash tank 320 moves contaminates from the wash tank 324 to the prewash tank 320. Since wash solution is entering the prewash tank 320, the volume of prewash solution would increase if not for the overflow outlet 408. The overflow outlet 408 allows prewash solution from the top surface of the prewash solution to be removed from the prewash tank 320. Most of the contaminants in the prewash solution are lighter than the prewash solution; therefore, the prewash solution that flows into the overflow outlet 408 removes contaminates from the prewash tank 320. The previously described method for introducing potable water into the rinse tank 328 and cascading the various solutions allows for constant rejuvenation of the solutions.

The tank assembly 300 may be provided with various manifolds for directing solution or pressurized air. Three exemplary manifolds will be described herein. After providing the description of the three exemplary manifolds, an exemplary orientation of the individual manifolds will be provided.

Referring to FIG. 3, a solution manifold 450 may be provided with a conduit 452, an inlet fitting 454, a mounting portion 456 and a plurality of outlets 470, 472, 474, 476, 478, 480, 482, 484, 486 and 488. The solution manifold 450 may be further provided with a plurality of spray nozzles such as spray nozzles 492, 494, 496, 498, 502, 504, 506 and 508. In the exemplary embodiment the spray nozzles 492, 494, 496, 498, 502, 504, 506 and 508 may be substantially similar to those obtained from Spraying Systems Company of Wheaton, Ill. under the model name UNIJET part number TT-40015-SS. The solution manifold 450 may be further provided with caps such as caps 490 and 500 for capping outlets that are not utilized. The conduit 452 is a substantially hollow member having a substantially water-impermeable construction. In the exemplary embodiment, stainless steel tube is provided having welded corners. The solution manifold 450 receives solution from a tank inlet, such as inlets 370, 374, 376, 378, 382 and 386, and deliver the solution to the various outlets, such as outlets 470, 472, 474, 476, 478, 480, 482, 484, 486 and 488. The spray nozzles, such as 492, 494, 496, 498, 502, 504, 506 and 508 deliver solution shown as a shaded region in FIG. 3. The particular configurations of the outlets provided with the solution manifold 450 may be varied as required to obtain a particular spray pattern. The mounting portion 456 is provided for attaching the solution manifold 450 to the tank assembly 300 by a number of methods well known in the art. Methods of mounting may include, but are not limited to, welds, rivets, threaded fasteners, adhesives, mechanical interlocks, etc..

Referring to FIG. 4, a top air manifold 550 may be provided with a conduit 552, a first fitting 554, a second fitting 556, a third fitting 558 and a mounting portion 560. The conduit 552 is a substantially hollow member having capped ends. In the exemplary embodiment, the conduit 552 is stainless steel tubing having a bent portion 562. The top air manifold 550 may be further provided with a first air nozzle 570 and a second air nozzle 572. The first and second air nozzles 570, 572 may be attached to the second and third fitting 556, 558, respectively. In the exemplary embodiment the first and second air nozzles 570, 572 may be substantially similar to those obtained from Spraying Systems Company of Wheaton, Ill. under the model name WINDJET part number 727-RY. The top air manifold 550 may receive compressed air from an inlet, such as inlets 372, 380, 384, 388 and 392, via a supply tube 574. The supply tube 574 may deliver the compressed air to the first fitting 554, which in turn delivers compressed air to the first and second air nozzles 570, 572. The particular configuration of the fittings provided with the top air manifold 550 may be varied as required for a particular spray pattern. The mounting portion 560 is provided for attaching the top air manifold 550 to the tank assembly 300 by a number of methods well known in the art. Methods of mounting may include, but are not limited to, welds, rivets, threaded fasteners, adhesives, mechanical interlocks, etc..

Referring to FIG. 5, a circular air manifold 600 may be provided with a conduit 602, plurality of fittings such as fitting 604, 606, 608, 610, 620, 622, 624, 626, 628 and 630, a mounting portion 640 and an opening 652. The conduit 602 is a substantially hollow member having capped ends. In the exemplary embodiment, the conduit 602 is stainless steel tubing having a plurality of bent portions 642, 644 and 646. The circular air manifold 600 may be further provided with a plurality of air nozzles such as air nozzle 648. In the exemplary embodiment the plurality of air nozzles such as air nozzle 648 may be substantially similar to those obtained from Spraying Systems Company of Wheaton, Ill. under the model name WINDJET part number 727-RY. The air nozzle 648 may be attached to the second fitting 620 or other fittings such as 604, 606, 608, 610, 620, 622, 624, 626, 628 and 630. The circular air manifold 600 may receive compressed air from an inlet, such as inlet 390, via a supply tube 650. The supply tube 650 delivers the compressed air to the fitting 390, which in turn delivers compressed air to the air nozzle 648. The particular configurations of the fittings provided with the circular air manifold 600 may be varied as required for a particular air pattern. The mounting portion 640 may be provided for attaching the circular air manifold 600 to the tank assembly 300 by a number of methods well known in the art. Methods of mounting may include, but are not limited to, welds, rivets, threaded fasteners, adhesives, mechanical interlocks, etc.

In an exemplary embodiment at shown in FIG. 2, the can washer 100 may be provided with a plurality of sprayer manifolds substantially similar to the sprayer manifold 450. A prewash sprayer 170, a first wash sprayer 174, a second wash sprayer 176, a third wash sprayer 178, a rinse sprayer 182 and a final rinse sprayer 186 may be provided with the can washer 100 and substantially similar to the sprayer manifold 450 as previously described. The prewash sprayer 170 is attached to the circumferential wall portion 302 in the general vicinity of the prewash tank 320. The first wash sprayer 174, the second wash sprayer 176 and the third wash sprayer 178 are attached to the circumferential wall portion 302 in the general vicinity of the wash tank 324. The rinse sprayer 182 is attached to the circumferential wall portion 302 and general vicinity of the rinse tank 328. The final rinse sprayer 186 is attached to the circumferential wall portion 302 in the general vicinity of the final rinse tank 332.

A prewash dryer 172, a washer dryer 180, a rinse dryer 184, a first final dryer 188 and a third final dryer 192 may be provided with the can washer 100 and substantially similar to the top air manifold 550. The prewash dryer 172 is attached to the circumferential wall portion 302 in the general vicinity of the prewash dryer recovery tank 322. The wash dryer 180 is attached to the circumferential wall portion 302 general vicinity of the wash dryer recovery tank 326. The rinse dryer 184 is attached to the circumferential wall portion 302 in the general vicinity of the rinse dryer recovery tank 330. The first final dryer 188 and the third final dryer 192 are attached to the circumferential wall portion 302 in the general vicinity of the final dryer tank 334.

A second final dryer 190 may be provided with the can washer 100 and substantially similar to the circular air manifold 600. The second final dryer 190 is attached to the circumferential wall portion 302 in the general vicinity of the final dryer tank 334.

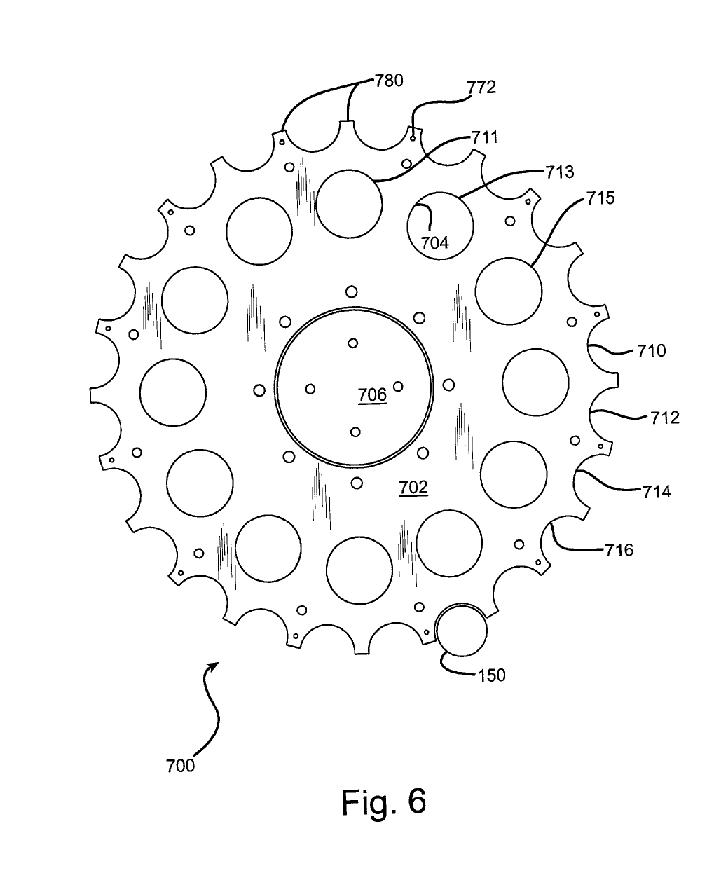

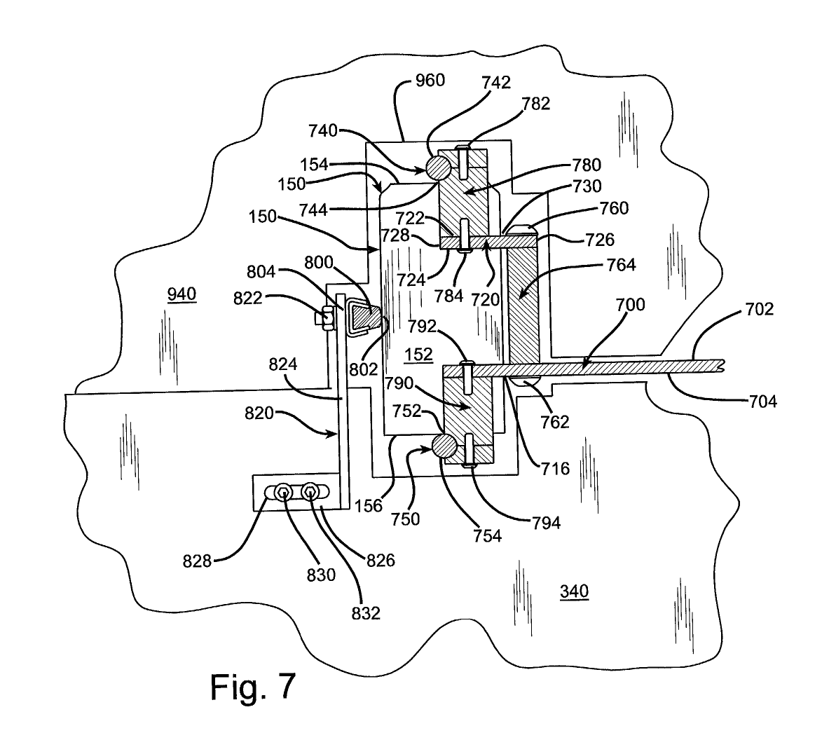

Referring to FIG. 6, the can washer 100 (FIG. 2) may be provided with a retention turntable 700. The retention turntable 700 may be provided with a top portion 702, a bottom portion 704, a center portion 706, a perimeter 708 and a plurality of can detents such as can detents 710, 712, 714 and 716. Additionally the retention turntable 700 may be provided with a plurality of drain holes such as drain holes 711, 713 and 715. Referring to FIG. 7, the retention turntable 700 may be provided with a top retention turntable 720.

The top retention turntable 720 may be provided with a top portion 722, a bottom portion 724, an inside portion 726, a perimeter 728 and a plurality of can detents such as can detent 730. The retention turntable 700 may be further provided with a top ring 740 and a bottom ring 750. The top ring 740 may be provided with a top portion 742 and a bottom portion 744. The bottom ring 750 may be provided with a top portion 752 and a bottom portion 754. The retention turntable 700 may be assembled with the top retention turntable 720, the top ring 740 and the bottom ring 750. The top retention turntable 720 may be attached with a plurality of stanchions such as stanchion 764 by a plurality of bolts such as bolts 760 and 762. The plurality of stanchions (such as stanchion 764) and plurality of bolts (such as 760 and 762) are provided circumferentially around the top portion 702 of the retention turntable 700 located at a plurality of stanchion holes such as stanchion holes 770, 772 and 774 (FIG. 6). The top ring 740 is mounted to the top retention turntable 720 by a plurality of top mounting clamps such as top mounting clamp 780 and a plurality of mounting bolts such as mounting bolts 782 and 784. The plurality of top mounting clamps such as top mounting clamp 780 are provided circumferentially around the top portion 722 of the top retention turntable 720 co-radial to the plurality of stanchion mounting bolts such as stanchion mounting bolts 760 and 762. The top mounting clamp 780 grips the top ring 740 and secures it by force applied by the mounting bolt 782. The bottom ring 750 is mounted to the retention turntable 700 by a plurality of bottom mounting clamps such as bottom mounting clamp 790 and a plurality of mounting bolts such as mounting bolts 792 and 794. The plurality of bottom mounting clamps such as bottom mounting clamp 790 are provided circumferentially around the bottom portion 704 of the retention turntable 700 co-radial to the plurality of stanchion mounting bolts such as stanchion mounting bolts 760 and 762. The bottom mounting clamp 790 grips the bottom ring 750 and secures it by force applied by the mounting bolt 794.

Referring to FIG. 8, the retention turntable 700 may be provided with a drive shaft 718. The drive shaft 718 may be mounted to the bottom portion 704 of the retention turntable 700. The drive shaft 718 and all components operatively attached thereto may be installed into the can washer 100 by a plurality of bearings such as the bearing 206. The drive shaft 718 may be rotated by the drive motor (not shown) located in the frame 200.

Therefore, the rotating drive shaft 718 rotates the retention turntable 700 and all components attached thereto within the can washer 100.

Referring to FIG. 7, the can washer 100 may be provided with a guide rail 800. The guide rail 800 may be provided with a front surface 802 and a mounting surface 804. The guide rail 800 may be further provided with a plurality of guide brackets such as guide bracket 820. The plurality of guide brackets such as guide bracket 820 may be provided with a guide rail bolt 822, a vertical portion 824, an interface portion 826 and a slot 828. The plurality of guide brackets such as guide bracket 820 are attached to the tank assembly 300 at the partition such as prewash partition 340. The interface portion 726 is attached to the prewash partition 340 by a pair of mounting bolts 830, 832. The guide rail 800 may be secured in the can washer 100 by the guide rail bolt 822 that secures the guide rail to the vertical portion 824. The guide rail 800 may be provided in a continuous semi-circular location as best shown in FIG. 2. In an exemplary embodiment the guide rail 800 is manufactured out of a wear-resistant material having a low coefficient of friction such as ultra-high molecular weight polyethylene (UHMW). The guide rail 800 may be substantial similar to those manufactured by Slus Industrial Innovations of 900C Tryens Road, Aston, Pa. under the name VALU GUIDE model name VG-SSR. Additionally the plurality of guide brackets such as guide bracket 820 may be positioned around the guide rail 800 for support at each of the partitions 304, 340, 342, 344, 346, 348, 350, 360 and 306.

Referring to FIG. 1, the can washer 100 may be provide with a cover 900. The cover 900 may be provided with an outside perimeter 902, a top portion 904, an entrance portion 906, an exit portion 908 and an inside portion 910 (FIG. 8). The cover 900 may be further provided with a top prewash window 920, a top wash window 922, a top rinse window 924, a top final rinse window 926 and a top dryer window 928. The cover 900 may be further provided with a prewash curtain 940, a prewash dryer curtain 942, a wash curtain 946, a wash dryer curtain 948, a rinse curtain 950, a rinse dryer curtain 952 and a dryer curtain 954. The curtains 940, 942, 946, 948, 950, 952 and 954 may be provided on the inside portion 910 of the cover 900. The individual curtains 940, 942, 946, 948, 950, 952 and 954, the entrance portion 906 and the exit portion 908 may be provided with openings such as opening 960 (FIG. 7) in the prewash curtain 940 (FIG. 7). The cover 900 may be further provided with a perimeter prewash window 960, a perimeter wash window 962, a perimeter rinse window 964, a perimeter final rinse window 966 and a perimeter dryer window 968. In the exemplary embodiment, the cover 900 is removably installed on the top portion of the tank assembly 300.

The exemplary embodiment as shown in FIG. 2 has a plurality of individual stations that correspond to the individual tanks 320, 322, 324, 326, 328, 330, 332 and 334. The plurality of stations will hereinafter be referred to as a prewash station 110, a prewash dryer station 112, a wash station 114, a wash dryer station 116, a rinse station 118, a rinse dryer station 120, a final rinse station 122 and a final dryer station 124. The prewash station 110 corresponds to the area located above the prewash tank 320. The prewash dryer station 112 corresponds to the area located above the prewash dryer tank 322. The wash station 114 corresponds to the area located above the wash tank 324. The wash dryer station 116 corresponds to the area located above the wash dryer tank 326. The rinse station 118 corresponds to the area located above the rinse tank 328. The rinse dryer station 120 corresponds to the area located above the rinse dryer tank 330. The final rinse station 122 corresponds to the area located above the final rinse tank 332. The final dryer station 124 corresponds to the area located above the final dryer tank 334.

A plurality of cans, such as can 150, may be introduced into the can washer 100 and travel in a semicircular direction 160. During the course of travel each individual can, such as can 150 travels through the plurality of stations such as stations 114, 116, 118, 120, 122 and 124. In the exemplary embodiment there are six of these stations, however it should be understood that there may be fewer or more stations depending on the particular sequence, solutions used, contaminates to be removed, etc.

Referring to FIG. 7, the exemplary can 150 may be provided with a circumferential wall 152, a bottom portion 154 and an open end 156. The can circumferential wall 152 is provided with a circular geometry. The bottom portion 154 may be located on a first end of the can circumferential wall 152 and the open end 156 may be oppositely disposed from the bottom portion 154. Therefore, the can 150 has a ‘cup’ geometry having the open end 156 and the closed bottom portion 154. In the exemplary embodiment, the can 150 is manufactured out of aluminum. Additionally, the exemplary aluminum can 150 may be altered in a number of ways depending on the particular volumetric requirements, can decoration, can composition, etc.

Having provided a detailed description of an exemplary embodiment of the can washer 100, a description of the operation will now be provided herein.

The can 150 may be introduced into the can washer 100 at the 132 by a conveyer system (not shown). Conveyer systems of this type are readily available by a variety of manufacturers. The can 150 may be introduced with an orientation such that the circumferential wall 152 is positioned vertical (thereby parallel to the direction of gravity). The can 150 may also be positioned such that the can bottom portion 154 is located above (i.e. away from the ground) the open end 156 as shown in FIG. 7 with this orientation, the can 150 does not collect solution against the bottom portion 154. It should be appreciated that this particular orientation may be altered depending on the particular geometry of the article to be washed.

The conveyer system (not shown) introduces the can 150 into one of the plurality of retention turntable can detents, such as retention turntable can detent 716. Referring to FIG. 7, the can bottom portion 154 may be in contact with the bottom portion 744 of the top ring 740. The can open end 156 may be in contact with the top portion 752 of the bottom ring 750. The can circumferential wall 152 may be in contact with the retention turntable can detent 716. The retention turntable 700 is rotating in the rotary direction 160. Therefore, the can 150 as captured by the can detent 716 on the retention turntable 700 rotates in the rotary direction 160. Shortly after rotating in the rotary direction 160, the can 150 may contact the guide rail 800. The can 150 may therefore be secured at a portion of the can circumferential wall 152 by the top retention turntable can detent 730 and the retention turntable can detent 716; an oppositely disposed portion of the can circumferential wall 152 may be secured by the guide rail 800. The interactions between the can detent 730, the can detent 716, the top ring 740, the bottom ring 750 and the guide rail 800 restrain the can 150 and resist forces applied thereto. Forces such as forces of sprayed solutions, air baffles curtains and centrifugal forces may be applied to the can as part of the cleaning process.

While rotating in the rotary direction 160, the can 150 passes the cover entrance portion 906 through an opening (not shown but substantially similar in geometry to the cover entrance portion 906 (FIG. 7)) and into the cover 900. While traveling through the cover 900, the guide rail 800 continues to contact the can circumferential wall 152 as previously described.

As can 150 travels in the rotary direction 160, it may pass through various stages. After entering the cover 900 the can 150 is located in the prewash station 110. While traveling through the prewash station 110, the can is sprayed by a prewash solution of sulfuric acid, hydrofluoric acid and surfactants. As previously mentioned, the prewash solution may be previously used wash solution. Additionally, the prewash solution may be heated to an elevated temperature such as 120 degrees Fahrenheit. The prewash solution is sprayed from the prewash sprayer 170. The sprayed prewash solution is obtained from the inlet 370 and plumbed to the plurality of nozzles as substantially shown in FIG. 3. After the sprayed prewash solution contacts the can 150, the prewash solution is collected in the prewash tank 320. The collected prewash solution is evacuated from the prewash tank 320 through the outlet 400. The evacuated prewash solution may travel from the outlet 400 into a pump (not shown) and reintroduced to the inlet 370. The recirculation of the prewash solution conserves the solution and minimizes the loss should total discharge be required. After traveling through the prewash station 110, the can 150 passes the prewash curtain 940 and the prewash partition 340 and into the prewash dryer station 112.

While traveling through the prewash dryer station 112, the can 150 is subjected to air discarded by the prewash dryer 172. The air discharged by the prewash dryer 172 blows any remaining prewash solution off the can 150 and into the prewash dryer recovery tank 322. The air being discharged by the prewash dryer 172 may be obtained from a conventional air compressor and introduced to the prewash dryer 172 through the inlet 372.

As can 150 continues to travel in the rotary direction 160, it may pass from the prewash dryer station 112 into the wash station 114 past the prewash dryer curtain 942 and the prewash dryer partition 342. While traveling through the wash station 114, the can 150 may be sprayed by a wash solution of sulfuric acid, hydrofluoric acid and surfactants. A controller may be provided that senses if component ratios are incorrect and adjusts component ratios as needed. Additionally, the prewash solution may be heated to an elevated temperature such as 120 degrees Fahrenheit. The wash solution may be sprayed from the first wash sprayer 174. The wash solution sprayed from the first wash sprayer 174 may be obtained from the inlet 374 and plumbed to the plurality of nozzles as substantially shown in FIG. 3. The wash solution may also be sprayed from the second wash sprayer 176. The wash solution sprayed from the second wash sprayer 176 may be obtained from the inlet 376 and plumbed to the plurality of nozzles as substantially shown in FIG. 3. The wash solution may also be sprayed from the third wash sprayer 178. The wash solution sprayed from the third wash sprayer 178 may be obtained from the inlet 378 and plumbed to the plurality of nozzles as substantially shown in FIG. 3. After the sprayed wash solution contacts the can 150, the wash solution may be collected in the wash tank 324. The collected wash solution may be evacuated from the wash tank 324 through the outlet 402. The evacuated wash solution may travel from the outlet 402 into a pump (not shown) and reintroduced to the inlets 374, 376 and 378. The recirculation of the wash solution conserves the solution and minimizes the loss should total discharge be required. After traveling through the wash station 114, the can 150 may pass the wash curtain 946 and the wash partition 344 and into the wash dryer station 116.

While traveling through the wash dryer station 116, the can 150 may be subjected to air discarded by the wash dryer 180. The air discharged by the wash dryer 180 may blow any remaining wash solution off of the can 150 and into the wash dryer recover tank 326. The air being sprayed by the wash dryer 180 may be obtained from a conventional air compressor and introduce to the wash dryer 180 through the inlet 380.

As can 150 continues to travel in the rotary direction 160, it may pass from the wash dryer station 116 into the rinse station 118 past the wash dryer curtain 948 and the wash dryer partition 346. While traveling through the rinse station 118, the can 150 may be sprayed by a rinse solution of potable water. The rinse solution may be sprayed from the rinse sprayer 182. The rinse solution sprayed from the rinse sprayer 182 may be obtained from the inlet 382 and plumbed to the plurality of nozzles as substantially shown in FIG. 3. After the sprayed rinse solution contacts the can 150, the rinse solution may be collected in the rinse tank 328. The collected rinse solution may be evacuated from the rinse tank 328 through the outlet 404. The evacuated rinse solution may travel from the outlet 404 into a pump (not shown) and reintroduced to the inlet 382. The recirculation of the rinse solution conserves the solution and minimizes the loss should total discharge be required. After traveling through the rinse station 118, the can 150 may pass the rinse curtain 950 and the rinse partition 348 and into the rinse dryer station 120.

While traveling through the rinse dryer station 120, the can 150 may be subjected to air discharged by the rinse dryer 184. The air discharged by the rinse dryer 184 may blow any remaining rinse solution off the can 150 and into the rinse dryer recovery tank 330. The air being discharged by the rinse dryer 184 may be obtained from a conventional air compressor and introduced to the rinse dryer 184 through the inlet 384.

As can 150 continues to travel in the rotary direction 160, it may pass from the rinse dryer station 120 into the final rinse station 122 past the rinse dryer curtain 952 and the rinse dryer partition 350. While traveling through the final rinse station 122, the can may be sprayed by a final rinse solution of deionized water. The final rinse solution may be sprayed from the final rinse sprayer 186. The final rinse solution sprayed from the 186 may be obtained from the final rinse sprayer 386 and plumbed to the plurality of nozzles as substantially shown in FIG. 3. After the sprayed final rinse solution contacts the can 150, the final rinse solution may be collected in the final rinse tank 332. The collected final rinse solution may be evacuated from the final rinse tank 332 through the outlet 406. The evacuated final rinse solution may travel from the outlet 406 into a pump (not shown) and reintroduced to the inlet 386. The recirculation of the final rinse solution conserves the solution and minimizes the loss should total discharge be required. After traveling through the final rinse station 122, the can 150 passes the dryer curtain 954 and the final rinse partition 360 and into the final dryer station 124.

While traveling through the final dryer station 124, the can 150 may be subjected to air discarded by the first final dryer 188, the second final dryer 190 and the third final dryer 192. The air discharge from the first final dryer 188, the second final dryer 190 and the third final dryer 192 may blow any remaining final rinse solution off of the can 150 and into the final dryer tank 334. The air being sprayed by the first final dryer 188, the second final dryer 190 and the third final dryer 192 may be obtained from a conventional air compressor and introduce to the first final dryer 188 through the inlet 388, inlet 390 and the inlet 392, respectively.

Upon traveling through the final dryer station 124, the can 150 may pass the exit portion 908 and enter the exit portion 132. At the exit portion 132 the can 150 may come into contact with a conventional conveyer system. The exiting can 150 may be substantially free of contaminates and ready to be introduced to additional manufacturing stations such as surface activation stations, printing stations, filling stations, etc.

In an alternative embodiment, holes may be provided to create varying depths of the internal tanks such as tanks 320, 324 and 328 (FIG. 2) denoted by “D” in FIG. 8. In this embodiment, holes may be provided in the internal tank partitions such as partitions 340, 342, 344 and 346 (FIG. 2) to create the varying depths. The holes allow the various solutions to cascade from one tank to another such as from the rinse tank 328 into the wash tank 324.

The present apparatus provides a modular approach to cleaning cans during the manufacturing process. Due to the small footprint and throughput capability of the apparatus, the apparatus may be installed near the bodymaker machine. With such installation, a plurality of smaller machines may take the place of a single large wash system as used in the prior art. Using a plurality of smaller machines in this manner allows portions of the production line to be shut down without causing the entire line to be shut down. When shutting down these individual stations, only the cans in the particular can washer are subject to over-processing. It can be appreciated by those in the art that fewer cans may require discarding due to over-processing versus the prior art washing system having a large number of cans therein.

An additional consideration of the individual stations is the size of the reservoir tanks. Since the present apparatus has smaller tanks, the effect of contamination may be minimized. In the event that rejuvenation of the solutions is required, only the particular individual solution in one tank needs to be rejuvenated. Additionally, in the event that the solution has become damaged beyond the point of rejuvenation, it may be discarded. The volume of discharged solution of the present apparatus is substantially smaller than the prior art devices.

Additionally, the present apparatus confines each individual can with minimal contact area therefore maximizing accessibility to solutions. As such, the cans are subjected directly to sprayed solutions rather than through conveyer belts or between ‘tubes’ created by other adjacent cans.

Since the cans in the high-speed washer 100 are confined, higher pressure sprayers may be used. The higher pressure sprayers provide additional mechanical cleaning action to remove contaminates from the cans. The higher pressure provides a mechanical cleaning action as well as the chemical cleaning action of the solution. The mechanical cleaning action is due to the higher velocity at which the solution is traveling as it contacts the cans. The present apparatus may be capable of spraying solutions in the range of 300-500 p.s.i. whereas the conventional systems provide pressures in the 50-60 p.s.i. range. It is noted that some objects are relatively light, such as aluminum cans that typically weigh 11 grams for a 12-ounce beverage can. The present apparatus confines light objects, i.e. aluminum cans, such that the pressure does not dislodge the object, whereas the prior art typically accommodates lower pressures.

Although in the exemplary embodiment the can 150 was used to describe the cleaning process, it is to be understood that the machine may be adapted to clean a variety of articles. As such, the present apparatus may be used to clean various articles other than cans.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A washer for washing objects, said washer comprising:
a housing;
a rotatable member rotatably mounted to said housing at a rotation axis;
wherein, said rotatable member has an outer peripheral surface extending in a direction parallel to said rotation axis;
at least one stationary member stationarily mounted to said housing;
wherein, at least one of said objects is in contact with both said rotatable member outer peripheral surface and said stationary member.

2. The washer of claim 1 wherein said stationary member has an arcuate profile.

3. The washer of claim 1 wherein said rotatable member outer periphery comprises a plurality of detents and wherein said at least one of said objects is engaged within at least one of said plurality of detents.

4. The washer of claim 1 wherein said housing comprises a cover and a tank.

5. The washer of claim 1 and further comprising at least one nozzle attached to said housing.

6. The washer of claim 5 wherein said nozzle has a spray axis and wherein said spray axis is perpendicular to said rotation axis.

7. The washer of claim 1, wherein said at least one of said objects comprises a can body.

8. The washer of claim 1 and further comprising:
a baffle attached to said housing, said baffle comprising an opening; and
wherein said opening is larger than a profile of said at least one of said objects.

9. The washer of claim 1 wherein:
said stationary member comprises at least one stationary member surface thereon;
said at least one stationary member surface extends in a direction parallel to said rotation axis; and
said at least one of said objects is in contact with said at least one stationary member surface.

10. The washer of claim 1 wherein said at least one of said objects is located between said rotatable member outer peripheral surface and said stationary member.

11. A method of washing an object, said method comprising:
providing a housing;
providing at least one nozzle within said housing providing a rotatable member rotatably mounted to said housing at a rotation axis, wherein said rotatable member has an outer peripheral surface extending in a direction parallel to said rotation axis;
providing at least one stationary member stationarily mounted to said housing;
rotating said rotatable member;
causing said object to move relative to said housing by contacting said object with said rotatable member outer peripheral surface;
guiding said object within said housing by contacting said object with said at least one stationary member; and
spraying fluid from said at least one nozzle onto said object while said rotating and said guiding are occurring.

12. The method of claim 11 wherein said stationary member has an arcuate profile.

13. The method of claim 11 wherein said rotatable member outer periphery comprises a plurality of detents and wherein said contacting said object with said rotatable member outer peripheral surface comprises contacting said object with at least one of said plurality of detents.

14. The method of claim 11 wherein said providing a housing comprises providing said housing having a cover and a tank.

15. The method of claim 11, wherein said object comprises a can body.

16. The method of claim 11 wherein:
said providing a housing comprises providing a baffle attached to said housing, wherein said baffle comprises an opening that is larger than a profile of said object.

17. The method of claim 11 wherein:
said providing at least one stationary member comprises providing said at least one stationary member comprising at least one stationary member surface thereon and said at least one stationary member surface extends in a direction parallel to said rotation axis; and
said contacting said object with said stationary member comprises contacting said object with said at least one stationary member surface.

18. The method of claim 11 wherein:
said spraying fluid from said at least one nozzle onto said object comprises spraying fluid in a first direction; and
wherein said first direction is perpendicular to said first axis.

19. A washer for washing objects, said washer comprising:
a housing;
a rotatable member rotatably mounted to said housing at a rotation axis;
at least one stationary member stationarily mounted to said housing;
wherein, at least one of said objects is located between said rotatable member and said at least one stationary member;
wherein, said at least one of said objects is in contact with both said rotatable member and said stationary member.

20. The washer of claim 19 wherein said stationary member has an arcuate profile.

21. The washer of claim 19 wherein said housing comprises a cover and a tank.

22. The washer of claim 19 and further comprising at least one nozzle attached to said housing.

23. The washer of claim 22 wherein said nozzle has a spray axis and wherein said spray axis is perpendicular to said rotation axis.

24. The washer of claim 1, wherein said at least one of said objects comprises a can body.

25. The washer of claim 1 and further comprising:
a baffle attached to said housing, said baffle comprising an opening; and
wherein said opening is larger than a profile of said at least one of said objects.
